(19) United States
(12) Patent Application Publication
(10) Pub. No.: US 2023/0113031 A1
(43) Pub. Date: Apr. 13, 2023

(54) TERMINAL, BASE STATION, AND COMMUNICATION METHOD

(71) Applicant: NTT DOCOMO, INC., Tokyo (JP)

(72) Inventors: Kouhei Harada, Chiyoda-Ku, Tokyo (JP); Akihito Hanaki, Chiyoda-ku, Tokyo (JP); Hideaki Takahashi, Chiyoda-ku, Tokyo (JP)

(73) Assignee: NTT DOCOMO, INC., Tokyo (JP)

(21) Appl. No.: 17/913,727

(22) PCT Filed: Apr. 9, 2020
(86) PCT No.: PCT/JP2020/016050

§ 371 Date: Sep. 22, 2022

(51) Int. Cl. H04W 28/06; H04W 76/12

(52) U.S. Cl. CPC H04W 28/06; H04W 76/12

(57) ABSTRACT

A terminal includes a transmitting unit that transmits a signaling message including information indicating a context to be established with a base station when there is one device corresponding to a transmission source address of the context to be established with the base station, the one device being connected to the terminal; and a control unit that attaches, to data, a compressed header corresponding to the context, when the data received from the one device is to be transmitted after transmitting the signaling message, wherein the transmitting unit transmits, to the base station, the data to which the compressed header is attached, the data not including a context identifier for identifying the context.

### TECHNICAL FIELD

The present invention relates to a terminal, a base station, and a communication method in a radio communication system.

### BACKGROUND ART

In the Ethernet (Registered Trademark) header compression procedure, a compressor transmits, to a decompressor, a notification of a Full Header (FH) of a packet and a Context ID (CID) associated with the FH. The de-compressor transmits a notification of feedback on the context to the compressor. Upon receiving the feedback, the compressor determines that the context is established and starts compressing the header. Namely, the compressor transmits a compressed header (CH: Compressed Header) to the de-compressor.

The design of the CID field (details of bit allocation) is being discussed at the 3GPP meeting. It is agreed to support the design of an extended CID field of 1 octet (=8 bits) and the design of an extended CID field of 2 octets. It is also agreed that RRC signaling is used to indicate whether a CID field to be used is the extended CID field of one octet or the extended CID field of two octets.

### RELATED ART DOCUMENT

### Non-Patent Document

Non-Patent Document 1: 3GPP TS 38.323 V15.6.0 (2019-06)

Non-Patent Document 2: 3GPP TS-RAN WG2 Meeting #109 electronic, R2-2000175, 24 Feb.-6 Mar. 2020

Non-Patent Document 3: White Paper, A 5G Traffi c Model for Industrial Use Cases, November 2019, 5G Alliance for Connected Industries and Automation https://www.5g-acia.org/fileadmin/5G-ACIA/Publikationen/5G-ACIA_White_Paper_Traffic_Model/WP_5G_5G_Traffic_Model_for_Industrial_Use_Cases_22.10.19.pdf

### SUMMARY OF THE INVENTION

### Problem to be Solved by the Invention

For example, if there are multiple Ethernet devices connected to a terminal, the terminal and/or a base station can identify a context (content of an Ethernet header) corresponding to a CID by using the Context ID (CID). However, when there is only one (single) Ethernet device connected to the terminal, since there is only one type of a context, the terminal and/or the base station can identify the context without using the CID.

There is a need for a method of reducing an overhead for transmitting an Ethernet frame.

### Means for Solving the Problem

According to an aspect of the present invention, there is provided a terminal including a transmitting unit that transmits a signaling message including information indicating a context to be established with a base station when there is one device corresponding to a transmission source address of the context to be established with the base station, the one device being connected to the terminal; and a control unit that attaches, to data, a compressed header corresponding to the context, when the data received from the one device is to be transmitted after transmitting the signaling message, wherein the transmitting unit transmits, to the base station, the data to which the compressed header is attached, the data not including a context identifier for identifying the context.

### Advantage of the Invention

According to an embodiment, a method of reducing an overhead for transmitting an Ethernet frame is provided.

### BRIEF DESCRIPTION OF DRAWINGS

FIG. 1 is a diagram illustrating an example of a configuration of a radio communication system according to an embodiment.

FIG. 2 is a diagram illustrating an example of a Uu interface between a terminal and a 5G-AN.

FIG. 3 is a diagram illustrating an example of a procedure of compressing a header.

FIG. 4 is a diagram illustrating an example of a configuration of a Full Header.

FIG. 5 is a diagram illustrating an example of a case in which a base station transmits header information to the terminal by using RRC signaling.

FIG. 6 is a diagram illustrating an example of a case in which the terminal transmits header information to the base station by using RRC signaling.

FIG. 7 is a diagram illustrating an example in which the base station transmits information indicating that a CID field is not to be used to the terminal by using RRC signaling.

FIG. 8 is a diagram illustrating an example of a functional configuration of the terminal.

FIG. 9 is a diagram illustrating an example of a functional configuration of the base station.

FIG. 10 is a diagram illustrating an example of the hardware configuration of the terminal and the base station.

### EMBODIMENTS OF THE INVENTION

In the following, embodiments of the present invention are described with reference to the drawings. The embodiments described below are merely examples, and the embodiments to which the present invention is applied are not limited to the following embodiments.

It is assumed that a radio communication system in the following embodiments basically conform to NR, but this is merely an example, and the radio communication system in the embodiments may partially or entirely conform to a radio communication system other than the NR (for example, LTE or LTE-A).

(Overall System Configuration)

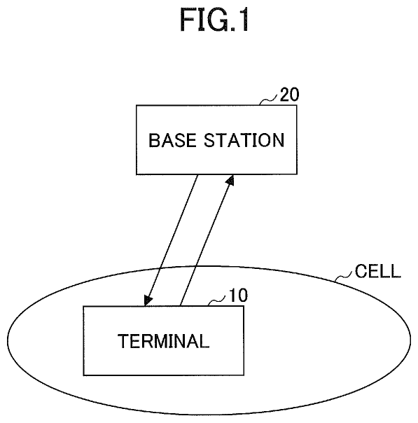

FIG. 1 is a diagram illustrating an example of a configuration of the radio communication system according to the embodiments. As illustrated in FIG. 1, the radio communication system according to the embodiments includes a terminal 10 and a base station 20 (which may be a base station simulator). In FIG. 1, one piece of the terminal 10 and one piece of the base station 20 are illustrated, but this is an example, and a plurality of the terminals 10 and a plurality of the base stations 20 may be provided. Note that, in a case where a base station simulator is used instead of the base station 20, instead of configuring a cell as illustrated in FIG. 1, a test environment may be formed by connecting the base station simulator and the terminal 10 by using a coaxial cable or the like after placing a fading simulator, an attenuator, and the like that intervene between the base station simulator and the terminal 10.

The terminal 10 is a communication device such as a smart phone, a portable telephone, a tablet, a wearable terminal, and a communication module for machine-to-machine (M2M) which has a radio communication function. The terminal 10 is wirelessly connected to the base station 20, and utilizes various types of communication services provided by the radio communication system. The base station 20 is a communication device that provides one or more cells, and wirelessly communicates with the terminal 10.

In the embodiments, a duplex method may be a time division duplex (TDD) method or a frequency division duplex (FDD) method.

In addition, in the embodiments, a radio parameter or the like is “configured” or “specified” may mean that a predetermined value is preconfigured in the base station 20 or the terminal 10, a predetermined value is assumed to be preconfigured in the base station 20 or the terminal 10, or a radio parameter transmitted from the base station 20 or the terminal 10 is configured.

The base station 20 is a communication device that provides one or more cells to perform wireless communication with the terminal 10. The physical resources of radio signals are defined in the time domain and the frequency domain. The time domain may be defined in the number of OFDM symbols (i.e., slots, subframes, symbols, time resources shorter than the symbols, or the like), and the frequency domain may be defined in the number of subcarriers or the number of resource blocks. The base station 20 transmits synchronization signals and system information to the terminal 10. The synchronization signals are NR-PSS and NR-SSS, for example. A part of the system information is transmitted on the NR-PBCH, for example, and is also called broadcast information. The synchronization signal and broadcast information may be transmitted periodically as the SS block (SS/PBCH block) formed of a predetermined number of OFDM symbols. The base station 20 transmits a control signal or data to the terminal 10 in the downlink (DL), and receives a control signal or data in the uplink (UL) from the terminal 10. Both the base station 20 and the terminal 10 are capable of using beam forming to transmit and receive signals. Reference signals transmitted from the base station 20 include a channel state information reference signal (CSI-RS), and channels transmitted from the base station 20 include a physical downlink control channel (PDCCH) and a physical downlink shared channel (PDCCH).

(EHC)

In 3GPP Release 16, Ethernet (registered trademark) Header Compression (EHC) for Industrial Internet of Things (IIoT) has been specified.

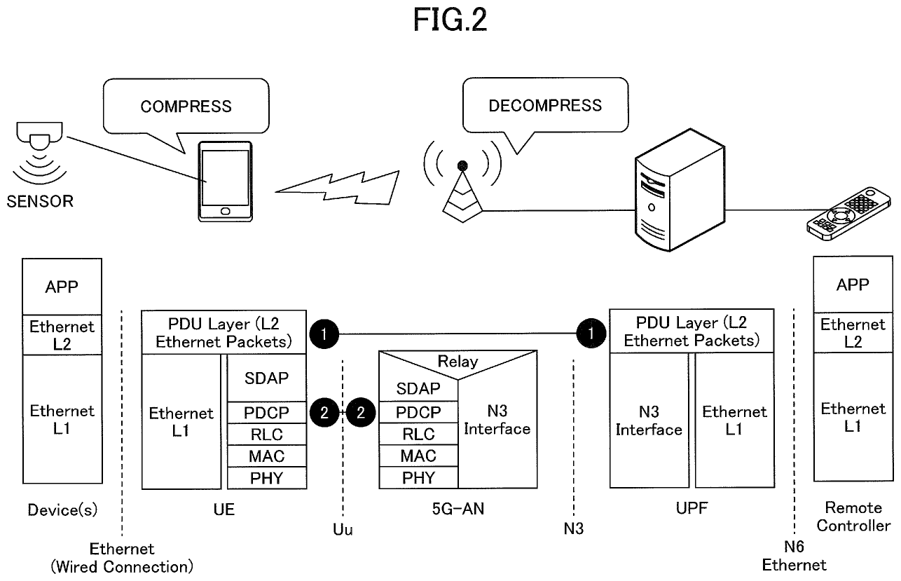

For example, as illustrated in the example of FIG. 2, when an Ethernet frame is transmitted and received between a terminal and a 5G-AN (Uu interface), the Ethernet header of the Ethernet frame is compressed.

For example, in a case of uplink communication, the Ethernet header compressed by a Packet Data Convergence Protocol (PDCP) entity of a terminal (UE) is decompressed by a PDCP entity of the 5G-AN, and the packet is transmitted to a remote controller by using the decompressed header information.

In the following description, the base station may include a compressor and a decompressor, and the terminal may include a compressor and a decompressor. In a case of downlink communication, the base station may operate as a compressor, and the terminal may operate as a decompressor. In a case of uplink communication, the base station may operate as a decompressor, and the terminal may operate as a compressor. In the following description, a context may be a content of an Ethernet header.

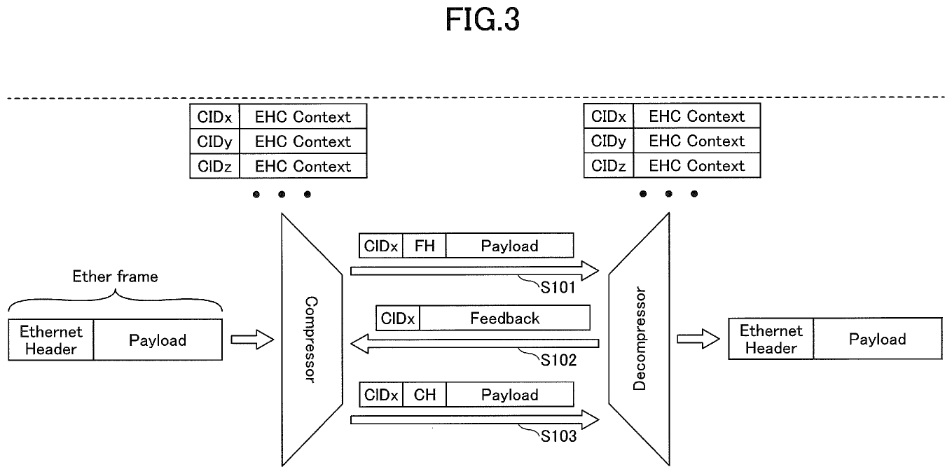

FIG. 3 is a diagram illustrating an example of a compression procedure of an Ethernet header. The compressor and the decompressor perform compression of the Ethernet (registered trademark) header as follows. In step S101, the compressor transmits, to the decompressor, a full header (FH) of a packet and a context ID (CID) associated with the FH.

In step S102, the decompressor transmits a feedback corresponding to the context to the compressor.

The compressor having received the feedback in step S102 determines that the context has been established, and starts compression of the header. In other words, in step S103, the compressor transmits compressed header (CH) to the decompressor.

In the above description, “the context has been established” may mean that a state in which a content of the same Ethernet header is shared by the compressor-side and the decompressor-side is established.

The above-described Ethernet header Compression (EHC) is executed by the PDCP entity. The order of protocol headers higher than the PDCP may be as follows.

PDCP header|SDAP header|EHC header|ROHC header|payload

In this specification, for convenience of the description, a Robust Header Compression (ROHC) header is not described. However, a PDCP entity transmitting user plane data may compress the ROHC header by using the ROHC compressor.

The EHC function can be applied in units of Data Radio Bearers (DRBs) for transmitting user plane data. The EHC function can be applied to any of the uplink and the downlink. When the DRB is added, the base station may indicate, to the terminal by using RRC signaling, whether the Ethernet header is to be compressed.

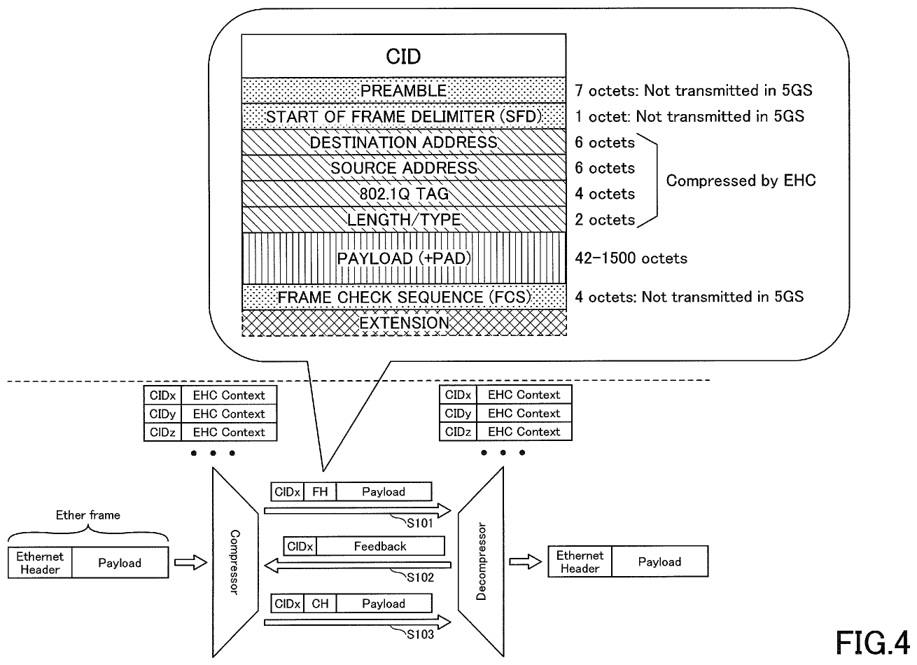

FIG. 4 is a diagram illustrating an example of a configuration of an Ethernet full header. A CID is attached before the Ethernet full header. As illustrated in the example of FIG. 4, the Ethernet full header may include a preamble of 7 octets, a start of frame delimiter (SFD) of 1 octet, a destination address of 6 octets, a transmission source address of 6 octets, an 802.1Q TAG of 4 octets, a LENGTH/TYPE of 2 octets, a PAYLOAD (+PAD) of 42 to 1500 octets, and a FRAME CHECK SEQUENCE (FCS) of 4 octets.

In the following description, a field may be an element of the Ethernet header and the CID. Types of fields may include the CID, a transmission MAC address, a reception MAC address, a Type/Length, and an 802.1Q TAG. The value may be a value stored in a field. The Ethernet frame may be an Ethernet header+payload.

(Context Notification by RRC in Ether Head Compression)

In the example of the system configuration of FIG. 2, in a case where multiple Ethernet Devices are present, the terminal 10 and/or the base station 20 uses the context ID (CID) to identify the context corresponding to the CID (the content of the Ethernet header). However, in the example of the system configuration of FIG. 2, in a case where there is one (i.e., a single) Ethernet Device connected to the terminal, the context is of a single type, and, thus, the terminal 10 and/or the base station 20 can identify the context without using the CID.

As an example in which there is one (single) Ethernet Device in the example of the system configuration of FIG. 2, 5G ACIA human-machine interface (HMI) or the like can be considered.

However, according to the technical specification, regardless of the number of Ethernet Devices, when a packet is to be transmitted, a CID is always attached before the full header/compressed header, and, thus, in a case where there is one (a single) Ethernet Device, 1 to 2 bytes of unnecessary data are transmitted per packet transmission.

(The Reason Why the Number of Ethernet Devices=the Number of Contexts)

In the RoHC, even if there is one transmitting device and one receiving device, if a source port or a destination port in a User Datagram Protocol (UDP) header is different, it is necessary to prepare another context. In contrast, in the case of the Ethernet, the transmission/reception MAC address is fixed for the device, and the Q-Tag is unnecessary if there is one Ethernet device, and, thus, the number of Ethernet devices can be considered to be the number of contexts.

(Proposed Method A)

In the example of the system configuration of FIG. 2, suppose that there is only one Ethernet device. In this case, the terminal 10 may transmit the header information to the base station 20 by using radio resource control (RRC) signaling for establishing a context with the base station 20. Similarly, the base station 20 may use RRC signaling to transmit header information to terminal 10 for establishing context with terminal 10.

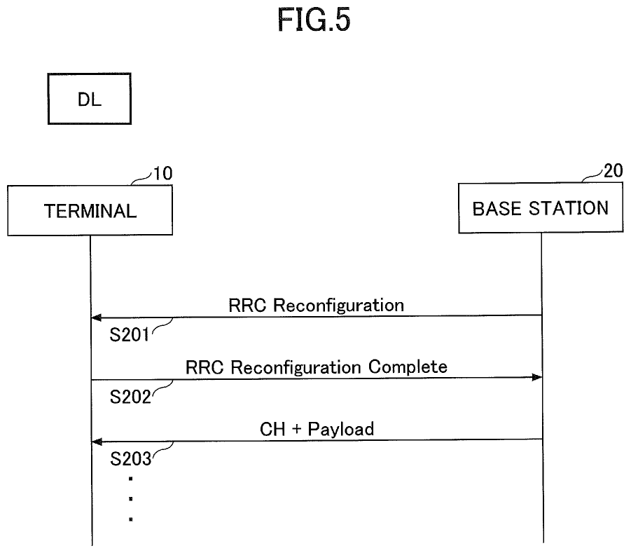

FIG. 5 is a diagram illustrating an example in a case where, when there is one (i.e., a single) Ethernet Device and the base station 20 is to establish a context with the terminal 10 in the downlink, the base station 20 transmits header information to the terminal 10 by using RRC signaling.

In step S201 of FIG. 5, during establishment of a DRB, the base station 20 includes Ethernet Full Header information in an RRC Reconfiguration message and transmits the RRC Reconfiguration message to the terminal 10.

In step S202 of FIG. 5, the terminal 10 transmits an RRC Reconfiguration Complete message to the base station 20.

In step S203 and subsequent steps of FIG. 5, the base station 20 attaches a compressed header (CH) to the payload without attaching the CID, and transmits the Ethernet frame.

In the example of FIG. 5, feedback information corresponding to step S102 of the example of FIG. 4 is not transmitted, but the embodiments are not limited to this example. For example, the terminal 10 may include feedback information corresponding to the received context in the RRC Reconfiguration Complete message to be transmitted in step S202 in the example of FIG. 5. Alternatively, the terminal 10 may transmit, separately from the RRC Reconfiguration Complete message of step S202, feedback information corresponding to the received context information to the base station 20.

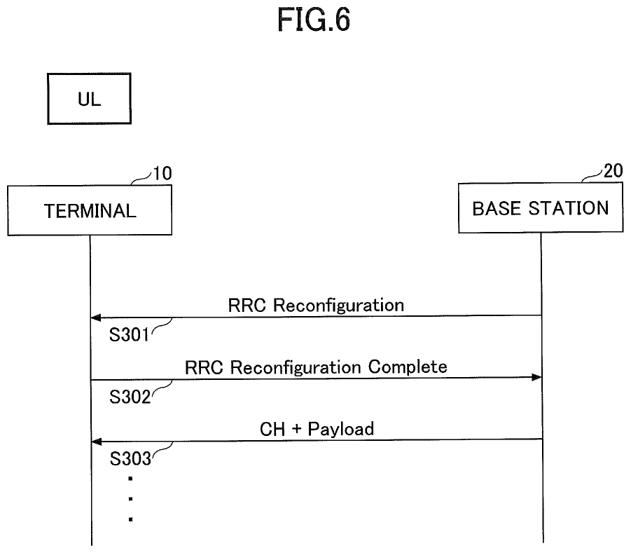

FIG. 6 is a diagram illustrating an example in a case in which, when there is one (i.e., a single) Ethernet Device and the terminal 10 is to establish a context with the base station 20 in the uplink, the terminal 10 transmits header information to the base station 20 by using RRC signaling.

In step S301 of FIG. 6, during establishment of a DRB, the terminal 10 receives, for example, an RRC Reconfiguration message from the base station 20.

In step S302 of FIG. 6, the terminal 10 includes Ethernet full header information in the RRC Reconfiguration complete message, and transmits the RRC Reconfiguration complete message to the base station 20.

In step S303 and subsequent steps of FIG. 6, the terminal 10 attaches a compressed header (CH) to the payload without attaching a CID and transmits the Ethernet frame.

In the example of FIG. 6, feedback information corresponding to step S102 of the example of FIG. 4 is not transmitted, but the embodiments are not limited this example. For example, after receiving the RRC Reconfiguration Complete message transmitted in step S302 in the example of FIG. 6, the base station 20 may transmit feedback information corresponding to the received context information to the terminal 10.

In the examples of FIG. 5 and FIG. 6, the RRC Reconfiguration message is used as the RRC message. However, the embodiments are not limited to these examples. For example, an RRC Resume message, an RRC Setup message, an RRC Connection Reconfiguration message, and the like may be used as the RRC message.

(Effect of Proposed Method A)

By integrating the U-plane procedure of the header compression into the C-plane procedure at bearer setting, the U-plane procedure can be omitted, and communication by using the compressed header can be performed from the initial packet. Furthermore, since it is not necessary to wait for feedback information for the transmitted context, it is possible to shorten the time until transmission using the CH is started on the transmitting side. In the normal context establishment procedure, since the FH is continuously transmitted until the transmitting side receives the feedback information for the transmitted context, the effect of shortening the time until the transmitting side starts the transmission using the CH becomes pronounced especially in the scenario of poor quality or large latency. Furthermore, since the transmitting side transmits the Ethernet full header information to the receiving side by RRC signaling, the procedure of step S101 and step S102 in FIG. 4 becomes unnecessary, and the overhead corresponding to the CID can be reduced. Furthermore, since it is not necessary to transmit the CID when transmitting the CH+Payload after the context is established, the overhead for transmitting the Ethernet frame is reduced.

(Proposed Method B)

In the example of the system configuration of FIG. 2, suppose that there is only one (single) Ethernet device. The design of the CID field (details of bit allocation) is being discussed at the 3GPP meeting. It is agreed to support the design of an extended CID field of 1 octet (=8 bits) and the design of an extended CID field of 2 octets. It is also agreed that RRC signaling is used to indicate whether a CID field to be used is the extended CID field of one octet or the extended CID field of two octets. In proposed method B, in addition to using the RRC signaling to indicate whether a CID field to be used is the extended CID field of one octet or the extended CID field of two octets, the RRC signaling may be used to transmit information indicating that the CID field is not to be used when the Ethernet frame is to be transmitted, after establishing the context.

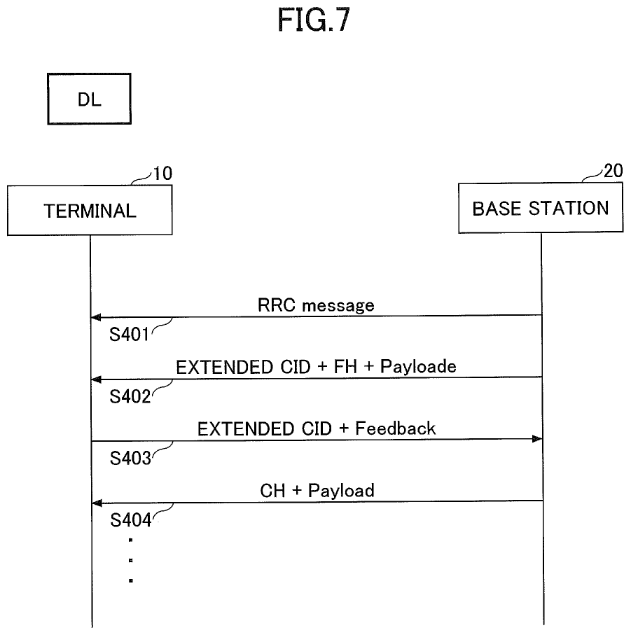

FIG. 7 is a diagram illustrating an example in which, in the case where there is only one (single) Ethernet device and the base station 20 is to establish a context with the terminal 10 in the downlink, in addition to using the RRC signaling to indicate whether a CID field to be used is the extended CID field of one octet or the extended CID field of two octets, the base station 20 uses the RRC signaling to transmit information indicating that the CID field is not to be used when the Ethernet frame is to be transmitted, after establishing the context.

In step S401 of FIG. 7, the base station 20 includes, in the RRC message, information indicating whether a CID field to be used is the extended CID field of one octet or the extended CID field of two octets and information indicating that the CID field is not to be used when the Ethernet frame is to be transmitted, after establishing the context. The base station 20 transmits the RRC message to the terminal 10.

In step S402 of FIG. 7, the base station 20 attaches, to the Payload, the Ethernet full header (FH), and further the CID associated with the FH. The base station 20 transmits the CID, the FH, and the Payload to the terminal 10.

In step S403 of FIG. 7, the terminal 10 attaches the CID to feedback information for the received content, and transmits, to the base station 20, the feedback information to which the CID is attached. The base station 20 having received the feedback information in step S403 determines that the context has been established with the terminal 10.

In step S401 of FIG. 7, the base station 20 transmits, to the terminal 10, an RRC signaling including information indicating that the CID field is not to be used when the Ethernet frame is to be transmitted. Accordingly, in step S404 and subsequent steps of FIG. 7, the base station 20 attaches a compressed header (CH) to the payload without attaching a CID and transmits, to the terminal 10, the payload to which the CH is attached.

Although FIG. 7 illustrates the example of the case of the downlink communication, proposed method B can be used even in the case of the uplink communication. In step S401 of FIG. 7, the base station 20 transmits, to the terminal 10, the RRC message including the information indicating that the CID field is not to be used, when an Ethernet frame is to be transmitted after the context has been established. However, the embodiments are not limited to this example. For example, in step S401 of FIG. 7, the base station 20 may transmit, to the terminal 10, the RRC message including information indicating that the CID field is to be used. In this case, during transmission of the Ethernet frame in step S404 and subsequent steps, the CH and the CID may be attached to the payload.

(Effect of Proposed Method B)

According to proposed method B, since it is unnecessary to transmit the CID when transmitting the CH+Payload after the context is established, the overhead for transmitting the Ethernet frame is reduced.

(Device Configuration)

In the following, examples of functional configuration of the terminal 10 and the base station 20 that execute the above-described processing operation are described. The terminal 10 and the base station 20 include all the functions described in the embodiments. However, it suffices for the terminal 10 and the base station 20 to include only a portion of the functions described in the embodiments.

<Terminal>

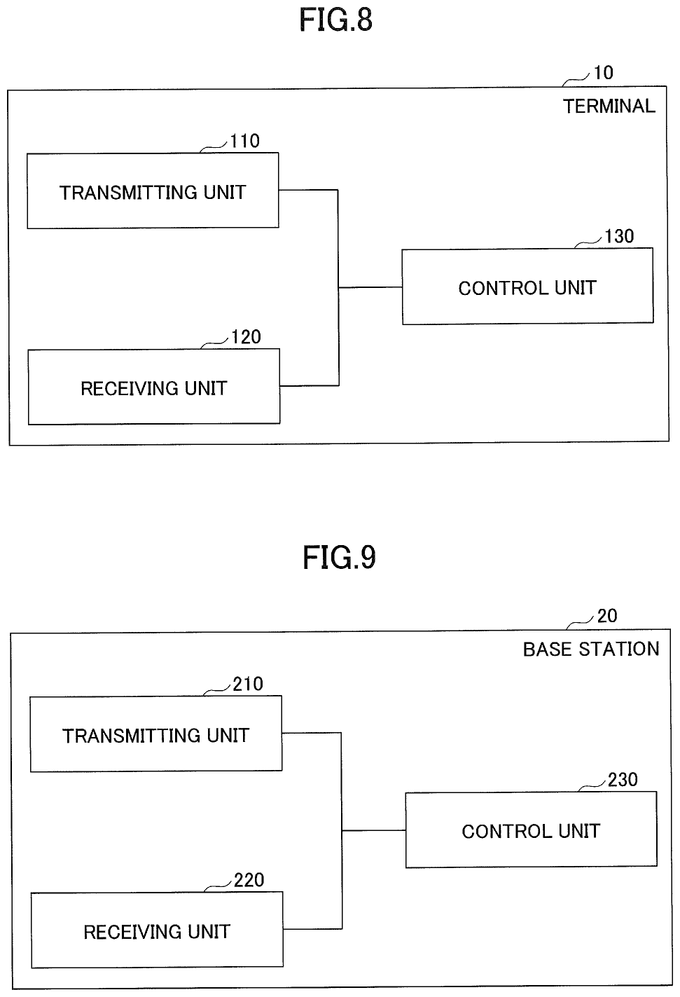

FIG. 8 is a diagram illustrating an example of the functional configuration of the terminal 10. As illustrated in FIG. 8, the terminal 10 includes a transmitting unit 110, a receiving unit 120, and a control unit 130. The functional configuration illustrated in FIG. 8 is only an example. The manner of function segmentation and the names of functional blocks do not matter as long as the operations of the embodiments can be performed.

The transmitting unit 110 generates transmission signals from transmission data, and transmits the transmission signals wirelessly. The receiving unit 120 receives various signals wirelessly, and acquires higher-layer signals from the received physical-layer signals. The receiving unit 120 includes a measuring unit that measures a received signal to acquire a reception power and the like.

The control unit 130 controls the terminal 10. The function of the control unit 130 relating to transmission may alternatively be included in the transmitting unit 110, and the function of the control unit 130 relating to reception may alternatively be included in the receiving unit 120.

For example, when there is only one device corresponding to the source address of the context to be established with the base station and the one device is connected to the terminal, the transmitting unit 110 of the terminal 10 transmits an RRC message including information indicating the context to be established with the base station. After transmitting the signaling message, when transmitting data received from the device, the control unit 130 of the terminal 10 attaches, to the data, a compressed header corresponding to the context. The transmitting unit 110 of the terminal 10 transmits, to the base station 20, the data to which the compressed header is attached and that does not include a context identifier for identifying the context.

For example, the transmitting unit 110 of the terminal 10 may include, in the RRC message, information indicating that the context identifier is not to be included when transmitting data.

<Base Station 20>

FIG. 9 is a diagram illustrating an example of the functional configuration of the base station 20. As illustrated in FIG. 9, the base station 20 includes a transmitting unit 210, a receiving unit 220, and a control unit 230. The functional configuration illustrated in FIG. 9 is only an example. The manner of function segmentation and the names of functional blocks do not matter as long as the operations according to the embodiments can be performed.

The transmitting unit 210 has the function to generate a signal to be transmitted to the terminal 10 and to transmit the signal wirelessly. The receiving unit 220 has the function to receive various signals transmitted from the terminal 10 and to acquire higher-layer information, for example, from the received signals. The receiving unit 220 includes a measuring unit that measures a received signal to acquire a reception power and the like.

The control unit 230 controls the base station 20. The function of the control unit 230 relating to transmission may alternatively be included in the transmitting unit 210, and the function of the control unit 230 relating to reception may alternatively be included in the receiving unit 220.

For example, when there is only one device corresponding to the transmission destination address of the context to be established with the terminal and the device is connected to the terminal, the transmitting unit 210 of the base station 20 transmits an RRC message including information indicating the context to be established with the terminal. The control unit 230 of the base station 20 attaches, to the data, a compressed header corresponding to the context when transmitting the data addressed to the device after the transmission of the signaling message. The transmitting unit 210 of the base station 20 transmits, to the terminal 10, the data to which the compressed header is attached and that does not include a context identifier for identifying the context.

For example, the transmitting unit 210 of the base station 20 may include, in an RRC message, information indicating that a context identifier is not to be included when transmitting data.

<Hardware Configuration>

The block diagrams (FIG. 8 to FIG. 9) used for the description of the above embodiments illustrate blocks of functional units. These functional blocks (components) are implemented by any combination of at least one of hardware or software. In addition, the implementation method of each functional block is not particularly limited. That is, each functional block may be implemented using a single device that is physically or logically combined, or may be implemented by directly or indirectly connecting two or more devices that are physically or logically separated (e.g., using wire or radio) and using these multiple devices. The functional block may be implemented by combining software with the above-described one device or the above-described plurality of devices. Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, and the like. For example, a functional block (component) that functions to transmit is called a transmitting unit or a transmission unit. In either case, as described above, the implementation method is not particularly limited.

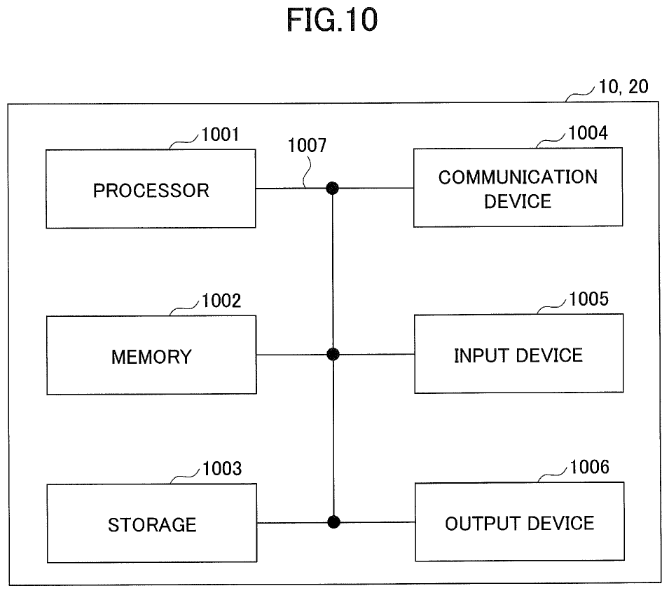

For example, the terminal 10 and the base station 20 according to the embodiments of the present invention may function as computers performing the process of the radio communication according to the embodiments of the present invention. FIG. 10 is a diagram illustrating an example of a hardware configuration of the terminal 10 and the base station 20 according to the embodiment. Each of the above-described terminal 10 and the base station 20 may be physically configured as a computer device including a processor 1001, a memory 1002, a storage 1003, a communication device 1004, an input device 1005, an output device 1006, a bus 1007, or the like.

Note that, in the following description, the term “device” can be replaced with a circuit, a device, a unit, or the like. The hardware configuration of the terminal 10 and the base station 20 may be configured to include one or more of the devices depicted in the figures, which are indicated by 1001 through 1006, or may be configured without some devices.

Each function of the terminal 10 and the base station 20 is implemented by loading predetermined software (program) on hardware, such as the processor 1001 and the memory 1002, so that the processor 1001 performs computation and controls communication by the communication device 1004, and at least one of reading and writing of data in the memory 1002 and the storage 1003.

The processor 1001, for example, operates an operating system to control the entire computer. The processor 1001 may be configured with a central processing unit (CPU: Central Processing Unit) including an interface with a peripheral device, a control device, a processing device, a register, or the like.

Additionally, the processor 1001 reads a program (program code), a software module, data, or the like from at least one of the storage 1003 and the communication device 1004 to the memory 1002, and executes various processes according to these. As the program, a program is used which causes a computer to execute at least a part of the operations described in the above-described embodiment. For example, the control unit 130 of the terminal 10 may be implemented by a control program that is stored in the memory 1002 and that is operated by the processor 1001. While the various processes described above are described as being executed in one processor 1001, they may be executed simultaneously or sequentially by two or more processors 1001. The processor 1001 may be implemented by one or more chips. The program may be transmitted from a network via a telecommunications line.

The memory 1002 is a computer readable storage medium, and, for example, the memory 1002 may be formed of at least one of a Read Only Memory (ROM), an Erasable Programmable ROM (EPROM), an Electrically Erasable Programmable ROM (EEPROM), and a Random Access Memory (RAM). The memory 1002 may be referred to as a register, a cache, a main memory (main storage device), or the like. The memory 1002 may store a program (program code), a software module, or the like, which can be executed for implementing the radio communication method according to the embodiments of the present disclosure.

The storage 1003 is a computer readable storage medium and may be formed of, for example, at least one of an optical disk, such as a Compact Disc ROM (CD-ROM), a hard disk drive, a flexible disk, an optical magnetic disk (e.g., a compact disk, a digital versatile disk, a Blu-ray (registered trademark) disk), a smart card, a flash memory (e.g., a card, a stick, a key drive), a floppy (registered trademark) disk, or a magnetic strip. The storage 1003 may be referred to as an auxiliary storage device. The above-described storage medium may be, for example, a database including at least one of the memory 1002 and the storage 1003, a server, or any other suitable medium.

The communication device 1004 is hardware (transmitting and receiving device) for performing communication between computers through at least one of a wired network and a wireless network, and is also referred to, for example, as a network device, a network control unit, a network card, a communication module, or the like. The communication device 1004 may be configured to include, for example, a high frequency switch, a duplexer, a filter, a frequency synthesizer, or the like to implement at least one of frequency division duplex (FDD: Frequency Division Duplex) and time division duplex (TDD: Time Division Duplex). For example, the above-described transmitting unit 110, receiving unit 120, and the like may be implemented by the communication device 1004. Furthermore, the transmitting unit 110 and the receiving unit 120 may be implemented to be physically or logically separated.

The input device 1005 is an input device (e.g., a keyboard, mouse, microphone, switch, button, or sensor) that receives an external input. The output device 1006 is an output device (e.g., a display, speaker, or LED lamp) that implements an external output. The input device 1005 and the output device 1006 may have an integrated configuration (for example, a touch panel).

Each device, such as the processor 1001 and the memory 1002, is also connected by the bus 1007 for communicating information. The bus 1007 may be formed of a single bus or may be formed of different buses between devices.

The terminal 10 and the base station 20 may each include hardware, such as a microprocessor, a digital signal processor (DSP: Digital Signal Processor), an Application Specific Integrated Circuit (ASIC), a Programmable Logic Device (PLD), and a Field Programmable Gate Array (FPGA), which may implement some or all of the functional blocks. For example, processor 1001 may be implemented using at least one of these hardware components.

### Conclusion of the Embodiments

In this specification, at least the following terminal, base station, and communication method are disclosed.

A terminal including a transmitting unit that transmits a signaling message including information indicating a context to be established with a base station when there is one device corresponding to a transmission source address of the context to be established with the base station, the one device being connected to the terminal; and a control unit that attaches, to data, a compressed header corresponding to the context, when the data received from the one device is to be transmitted after transmitting the signaling message, wherein the transmitting unit transmits, to the base station, the data to which the compressed header is attached, the data not including a context identifier for identifying the context.

According to the above-described configuration, by integrating the U-plane procedure of the header compression into the C-plane procedure at bearer setting, the U-plane procedure can be omitted, and communication by using the compressed header can be performed from the initial packet. Furthermore, since it is not necessary to wait for feedback information for the transmitted context, it is possible to shorten the time until transmission using the CH is started on the transmitting side. Furthermore, after the context is established, an Ethernet frame can be transmitted without including a context identifier. Accordingly, an overhead for transmitting data can be reduced.

The signaling message may include information indicating that the context identifier is not to be included when the data is to be transmitted.

According to the above-described configuration, the base station side can confirm, in advance, that data to be received does not include the context identifier.

Even when the terminal does not receive feedback for the context from the base station after transmitting the signaling message, the transmitting unit may transmit, to the base station, the data to which the compressed header is attached, the data not including the context identifier for identifying the context.

According to the above-described configuration, since it is not necessary to wait for feedback information for the transmitted context, it is possible to shorten the time until transmission using the CH is started on the transmitting side.

A base station including a transmitting unit that transmits a signaling message including information indicating a context to be established with a terminal when there is one device corresponding to a transmission source address of the context to be established with the terminal, the one device being connected to the terminal; and a control unit that attaches, to data, a compressed header corresponding to the context, when the data addressed to the one device is to be transmitted after transmitting the signaling message, wherein the transmitting unit transmits, to the terminal, the data to which the compressed header is attached, the data not including a context identifier for identifying the context.

According to the above-described configuration, by integrating the U-plane procedure of the header compression into the C-plane procedure at bearer setting, the U-plane procedure can be omitted, and communication by using the compressed header can be performed from the initial packet. Furthermore, since it is not necessary to wait for feedback information for the transmitted context, it is possible to shorten the time until transmission using the CH is started on the transmitting side. Furthermore, after the context is established, an Ethernet frame can be transmitted without including a context identifier. Accordingly, an overhead for transmitting data can be reduced.

A communication method executed by a terminal, the method including transmitting a signaling message including information indicating a context to be established with a base station when there is one device corresponding to a transmission source address of the context to be established with the base station, the one device being connected to the terminal; attaching, to data, a compressed header corresponding to the context, when the data received from the one device is to be transmitted after transmitting the signaling message; and transmitting, to the base station, the data to which the compressed header is attached, the data not including a context identifier for identifying the context.

According to the above-described configuration, by integrating the U-plane procedure of the header compression into the C-plane procedure at bearer setting, the U-plane procedure can be omitted, and communication by using the compressed header can be performed from the initial packet. Furthermore, since it is not necessary to wait for feedback information for the transmitted context, it is possible to shorten the time until transmission using the CH is started on the transmitting side. Furthermore, after the context is established, an Ethernet frame can be transmitted without including a context identifier. Accordingly, an overhead for transmitting data can be reduced.

### Supplemental Embodiments

While the embodiments of the present invention are described above, the disclosed invention is not limited to the embodiments, and those skilled in the art will appreciate various alterations, modifications, alternatives, substitutions, or the like. Descriptions are provided using specific numerical examples to facilitate understanding of the invention, but, unless as otherwise specified, these values are merely examples and any suitable value may be used. Classification of the items in the above descriptions is not essential to the present invention, and the items described in two or more items may be used in combination as needed, or the items described in one item may be applied (as long as there is no contradiction) to the items described in another item. The boundaries of functional units or processing units in the functional block diagram do not necessarily correspond to the boundaries of physical components. An operation by a plurality of functional units may be physically performed by one component or an operation by one functional unit may be physically executed by a plurality of components. For the processing procedures described in the embodiments, the order of processing may be changed as long as there is no contradiction. For the convenience of the description of the process, the terminal 10 and the base station 20 are described using functional block diagrams, but such devices may be implemented in hardware, software, or a combination thereof. Software operated by a processor included in the terminal 10 in accordance with the embodiments of the present invention and software operated by a processor included in the base station 20 in accordance with the embodiments of the present invention may be stored in a random access memory (RAM), a flash memory, a read-only memory (ROM), an EPROM, an EEPROM, a register, a hard disk (HDD), a removable disk, a CD-ROM, a database, a server, or any other suitable storage medium.

Notification of information is not limited to the aspects/embodiments described in the disclosure, and notification of information may be made by another method. For example, notification of information may be implemented by physical layer signaling (e.g., Downlink Control Information (DCI), Uplink Control Information (UCI), higher layer signaling (e.g., Radio Resource Control (RRC) signaling, Medium Access Control (MAC) signaling, broadcast information (Master Information Block (MIB), System Information Block (SIB))), or other signals or combinations thereof. RRC signaling may be referred to as an RRC message, for example, which may be an RRC connection setup message, an RRC connection reconfiguration message, or the like.

The aspects/embodiments described in this disclosure may be applied to a system using at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), any other appropriate system, and a next generation system extended based on theses. Additionally, a plurality of systems may be combined (e.g., a combination of at least one of LTE and LTE-A and 5G) to be applied.

The processing procedures, sequences, flow charts, and the like of each aspect/embodiment described in this disclosure may be reordered, provided that there is no contradiction. For example, the methods described in this disclosure present elements of various steps in an exemplary order and are not limited to the particular order presented.

The particular operation described in this disclosure to be performed by the base station 20 may be performed by an upper node in some cases. It is apparent that in a network consisting of one or more network nodes having the base station 20, various operations performed for communicating with the terminal may be performed by at least one of the base station 20 and a network node other than the base station 20 (e.g., MME or S-GW can be considered, however, the network node is not limited to these). The case is exemplified above in which there is one network node other than the base station 20. However, the network node other than the base station 20 may be a combination of multiple other network nodes (e.g., MME and S-GW).

Input and output information may be stored in a specific location (e.g., memory) or managed using management tables. Input and output information may be overwritten, updated, or added. Output information may be deleted. The input information may be transmitted to another device.

The determination may be made by a value (0 or 1) represented by 1 bit, by a true or false value (Boolean: true or false), or by comparison of numerical values (e.g., a comparison with a predefined value).

The aspects/embodiments described in this disclosure may be used alone, in combination, or switched with implementation. Notification of predetermined information (e.g. “X” notice) is not limited to a method that is explicitly performed, and may also be made implicitly (e.g. “no notice of the predetermined information”).

Software should be broadly interpreted to mean, regardless of whether referred to as software, firmware, middleware, microcode, hardware description language, or any other name, instructions, sets of instructions, code, code segments, program code, programs, subprograms, software modules, applications, software applications, software packages, routines, subroutines, objects, executable files, executable threads, procedures, functions, or the like.

Software, instructions, information, or the like may also be transmitted and received via a transmission medium. For example, when software is transmitted from a website, server, or other remote source using at least one of wireline technology (such as coaxial cable, fiber optic cable, twisted pair, digital subscriber line) and wireless technology (e.g., infrared or microwave), at least one of these wireline technology and wireless technology is included within the definition of a transmission medium.

The information, signals, or the like described in this disclosure may be represented using any of a variety of different techniques. For example, data, instructions, commands, information, signals, bits, symbols, chips, or the like which may be referred to throughout the above description may be represented by voltages, currents, electromagnetic waves, magnetic fields or magnetic particles, optical fields or photons, or any combination thereof.

The terms described in this disclosure and those necessary for understanding this disclosure may be replaced by terms having the same or similar meanings. For example, at least one of the channels and the symbols may be a signal (signaling). The signal may also be a message. Furthermore, a component carrier (CC: Component Carrier) may be referred to as a carrier frequency, a cell, a frequency carrier, or the like.

As used in this disclosure, the terms “system” and “network” are used interchangeably. The information, parameters, or the like described in the present disclosure may also be expressed using absolute values, relative values from predetermined values, or they may be expressed using corresponding separate information. For example, radio resources may be those indicated by an index.

The names used for the parameters described above are not restrictive in any respect. In addition, the mathematical equations using these parameters may differ from those explicitly disclosed in this disclosure. Since the various channels (e.g., PUCCH or PDCCH) and information elements can be identified by any suitable name, the various names assigned to these various channels and information elements are not in any way limiting.

In this disclosure, the terms “Base Station,” “Radio Base Station,” “Fixed Station,” “NodeB,” “eNodeB(eNB),” “gNodeB (gNB),” “Access Point,” “Transmission Point,” “Reception Point,” “Transmission/Reception Point,” “Cell,” “Sector,” “Cell Group,” “Carrier,” “Component Carrier,” and the like may be used interchangeably. The base stations may be referred to in terms such as macro-cell, small-cell, femto-cell, or pico-cell.

The base station can accommodate one or more (e.g., three) cells. Where the base station accommodates a plurality of cells, the entire coverage area of the base station can be divided into a plurality of smaller areas, each smaller area can also provide communication services by means of a base station subsystem (e.g., an indoor small base station (RRH) or a remote Radio Head). The term “cell” or “sector” refers to a portion or all of the coverage area of at least one of the base station and base station subsystem that provides communication services at the coverage.

In this disclosure, terms such as “mobile station (MS: Mobile Station)”, “user terminal”, “user equipment (UE: User Equipment)”, “terminal”, or the like may be used interchangeably.

The mobile station may be referred to by one of ordinary skill in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term.

At least one of a base station and a mobile station may be referred to as a transmission unit, receiver, communication device, or the like. At least one of a base station and a mobile station may be a device installed in a mobile body, a mobile body itself, or the like. The mobile body may be a vehicle (e.g., a car or an airplane), an unmanned mobile (e.g., a drone or an automated vehicle), or a robot (manned or unmanned). At least one of a base station and a mobile station includes a device that does not necessarily move during communication operations. For example, at least one of a base station and a mobile station may be an Internet of Things (IoT) device such as a sensor.

In addition, the base station in the present disclosure may be replaced with the user terminal. For example, various aspects/embodiments of the present disclosure may be applied to a configuration in which communication between the base station and the user terminal is replaced with communication between multiple user terminals (e.g., may be referred to as Device-to-Device (D2D) or Vehicle-to-Everything (V2X)). In this case, a configuration may be such that the above-described function of the base station 20 is included in the terminal 10. The terms “up” and “down” may also be replaced with the terms corresponding to terminal-to-terminal communication (e.g., “side”). For example, an uplink channel, a downlink channel, or the like may be replaced with a sidelink channel. Similarly, the user terminal according to the present disclosure may be replaced with a base station. In this case, a configuration may be such that, the function included in the above-described terminal 10 may be included in the base station 20.

The term “connected” or “coupled” or any variation thereof means any direct or indirect connection or connection between two or more elements and may include the presence of one or more intermediate elements between two elements “connected” or “coupled” with each other. The coupling or connection between the elements may be physical, logical, or a combination of these. For example, “connection” may be replaced with “access”. As used in the present disclosure, the two elements may be considered as being “connected” or “coupled” to each other using at least one of the one or more wires, cables, and printed electrical connections and, as a number of non-limiting and non-inclusive examples, electromagnetic energy having wavelengths in the radio frequency region, the microwave region, and the light (both visible and invisible) region.

The reference signal may be abbreviated as RS (Reference Signal) or may be referred to as a pilot, depending on the standard applied.

As used in this disclosure, the expression “based on” does not mean “based on only” unless otherwise specified. In other words, the expression “based on” means both “based on only” and “at least based on.”

As long as “include,” “including,” and variations thereof are used in this disclosure, the terms are intended to be inclusive in a manner similar to the term “comprising.” Furthermore, the term “or” used in the disclosure is intended not to be an exclusive OR.

In the present disclosure, for example, if an article is added by translation, such as “a,” “an,” and “the” in English, the present disclosure may include that the noun following the article is plural.

In the present disclosure, the term “A and B are different” may imply that “A and B are different from each other.” Note that the term may also imply “each of A and B is different from C.” The terms, such as “separated” or “coupled,” may also be interpreted similarly.

While the present invention is described in detail above, those skilled in the art will appreciate that the present invention is not limited to the embodiments described in this specification. The present invention may be implemented as modifications and variations without departing from the gist and scope of the present invention as defined by the claims. Accordingly, the description of this specification is for illustrative purposes only and is not intended to have any restrictive meaning with respect to the present invention.

### LIST OF REFERENCE SYMBOLS

10 terminal

110 transmitting unit

120 receiving unit

130 control unit

20 base station

210 transmitting unit

220 receiving unit

230 control unit

1001 processor

1002 memory

1003 storage

1004 communication device

1005 input device

1006 output device

1. A terminal comprising:
a transmitting unit that transmits a signaling message including information indicating a context to be established with a base station when there is one device corresponding to a transmission source address of the context to be established with the base station, the one device being connected to the terminal; and
a control unit that attaches, to data, a compressed header corresponding to the context, when the data received from the one device is to be transmitted after transmitting the signaling message,
wherein the transmitting unit transmits, to the base station, the data to which the compressed header is attached, the data not including a context identifier for identifying the context.

2. The terminal according to claim 1, wherein the signaling message includes information indicating that the context identifier is not to be included when the data is to be transmitted.

3. The terminal according to claim 1, wherein, even when the terminal does not receive feedback for the context from the base station after transmitting the signaling message, the transmitting unit transmits, to the base station, the data to which the compressed header is attached, the data not including the context identifier for identifying the context.

4. A base station comprising:
a transmitting unit that transmits a signaling message including information indicating a context to be established with a terminal when there is one device corresponding to a transmission source address of the context to be established with the terminal, the one device being connected to the terminal; and
a control unit that attaches, to data, a compressed header corresponding to the context, when the data addressed to the one device is to be transmitted after transmitting the signaling message,
wherein the transmitting unit transmits, to the terminal, the data to which the compressed header is attached, the data not including a context identifier for identifying the context.

5. A communication method executed by a terminal, the method comprising:
transmitting a signaling message including information indicating a context to be established with a base station when there is one device corresponding to a transmission source address of the context to be established with the base station, the one device being connected to the terminal;
attaching, to data, a compressed header corresponding to the context, when the data received from the one device is to be transmitted after transmitting the signaling message; and
transmitting, to the base station, the data to which the compressed header is attached, the data not including a context identifier for identifying the context.
